(19) United States
(12) Patent Application Publication
(10) Pub. No.: US 2015/0142189 A1
(43) Pub. Date: May 21, 2015

(54) POWER GENERATION CONTROL SYSTEM, METHOD AND NON-TRANSITORY COMPUTER READABLE STORAGE MEDIUM OF THE SAME

(71) Applicant: INSTITUTE FOR INFORMATION INDUSTRY, Taipei (TW)

(72) Inventors: Chia-Shin Yen, Taipei City (TW); Woei-Luen Chen, Taipei City (TW); Yi-Cheng Liu, New Taipei City (TW)

(73) Assignee: INSTITUTE FOR INFORMATION INDUSTRY, Taipei (TW)

(21) Appl. No.: 14/166,549

(22) Filed: Jan. 28, 2014

(30) Foreign Application Priority Data
Nov. 15, 2013 (TW) 102141708

(51) Int. Cl. G05B 15/02; G05F 1/10

(52) U.S. Cl. CPC G05B 15/02; G05F 1/10
USPC 700/287

(57) ABSTRACT

A power generation control system is provided. The power generation control system includes power generation devices electrically connected to form an array, a MPPT module, a power control module and voltage control modules. Each of the power generation devices includes an energy generation module for generating input supplying power and a MVPT module for performing a MVPT process on the input supplying power. The MPPT module performs a MPPT process on the total output supplying power from the power generation devices to generate a maximum supplying power. The power control module controls the MPPT module to perform the MPPT process. Each of the voltage control modules controls the MVPT modules to perform the MVPT process.

### RELATED APPLICATIONS

This application claims priority to Taiwan Application Serial Number 102141708, filed Nov. 15, 2013, which is herein incorporated by reference.

### BACKGROUND

1. Field of Invention

The present invention relates to power generating technology. More particularly, the present invention relates to a power generation control system, a method and a non-transitory computer readable storage medium of the same.

2. Description of Related Art

Since energy demands are gradually increasing, the use of renewable energy becomes an important issue in the subject of energy development. The renewable energy is energy which comes from natural resources that are continually replenished. The renewable energy include such as solar energy, wind energy, hydroelectric energy, tide energy or biomass energy. In recent years, lots of researches focus on the solar energy. Hence, the solar energy is especially important.

However, a problem with renewable energy is that it is unstable. For example, the energy production of a solar cell system primarily depends on the weather conditions of the geographical location where the system is installed. When the angle of the sunlight changes or part of energy generation blocks in a solar cell module do not operate normally since they are blocked by objects such as buildings, the efficiency of the solar cell module greatly decreases if there is no countermeasure.

Accordingly, what is needed is a power generation control system, a method and a non-transitory computer readable storage medium of the same to efficiently maintain a steady output power even if the renewable energy generation module does not function normally.

### SUMMARY

An aspect of the present invention is to provide a power generation control system. The power generation control system includes a plurality of supplying power generation devices, a maximum power point tracking (MPPT) module, a power control module and a plurality of voltage control modules. The supplying power generation devices are electrically connected to form an array, each including an energy generation module and a maximum voltage point tracking (MVPT) module. The energy generation module generates an input supplying power. The MVPT module is electrically connected to the energy generation module for performing a MVPT process on the input supplying power to generate an output supplying power. The MPPT module is electrically connected to the supplying power generation devices for performing a MPPT process on a total output supplying power generated from the supplying power generation devices to generate a maximum supplying power having a maximum power. The power control module is electrically connected to the MPPT module for generating a first duty cycle control signal according to a total output voltage and a total output current of the total output supplying power to control the MPPT module to perform the MPPT process. Each of the voltage control modules is electrically connected to the MVPT module of one of the supplying power generation devices for generating a second duty cycle control signal according to an output voltage of the output supplying power to control the MVPT module to perform the MVPT process.

Another aspect of the present invention is to provide a power generation control method used in a power generation control system. The power generation control method includes the steps outlined below. A MVPT module in each of a plurality of supplying power generation devices connected in series is controlled to receive an input power generated from an energy generation module to generate an output supplying power. A MPPT module is controlled to generate a maximum supplying power having a maximum power according to a total output supplying power generated from the supplying power generation devices. A first duty cycle control signal is generated according to a total output voltage and a total output current of the total output supplying power to control the MPPT module to perform a MPPT process on the total output supplying power. A second duty cycle control signal is generated according to an output voltage of the output supplying power of each of the supplying power generation devices to control the MVPT module to perform the MVPT process on the output supplying power.

Yet another aspect of the present invention is to provide a non-transitory computer readable storage medium to store a computer program to execute a power generation control method used in a power generation control system. The power generation control method includes the steps outlined below. A MVPT module in each of a plurality of supplying power generation devices connected in series is controlled to receive an input power generated from an energy generation module to generate an output supplying power. A MPPT module is controlled to generate a maximum supplying power having a maximum power according to a total output supplying power generated from the supplying power generation devices. A first duty cycle control signal is generated according to a total output voltage and a total output current of the total output supplying power to control the MPPT module to perform a MPPT process on the total output supplying power. A second duty cycle control signal is generated according to an output voltage of the output supplying power of each of the supplying power generation devices to control the MVPT module to perform the MVPT process on the output supplying power.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a block diagram of a power generation control system in an embodiment of the present invention.

FIG. 1B is a detail block diagram of the power generation control system illustrated in FIG. 1A in an embodiment of the present invention.

FIG. 2 is a detail circuit diagram of the supplying power generation device in an embodiment of the present invention.

FIG. 3 is a waveform diagram of a plurality of examples of the second duty cycle control signal having different duty cycles in an embodiment of the present invention.

FIG. 4 and FIG. 5 are diagrams of the curves of the total output voltage and the total output current of the total output supplying power in an embodiment of the present invention.

FIG. 6 is a flow chart of a power generation control method in an embodiment of the present invention.

FIG. 7 is a flow chart of the MPPT process in an embodiment of the present invention.

FIG. 8 is a diagram illustrating a curve of the total output power and the total output current of the total output supplying power in an embodiment of the present invention.

FIG. 9 is a flow chart of the MVPT process in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

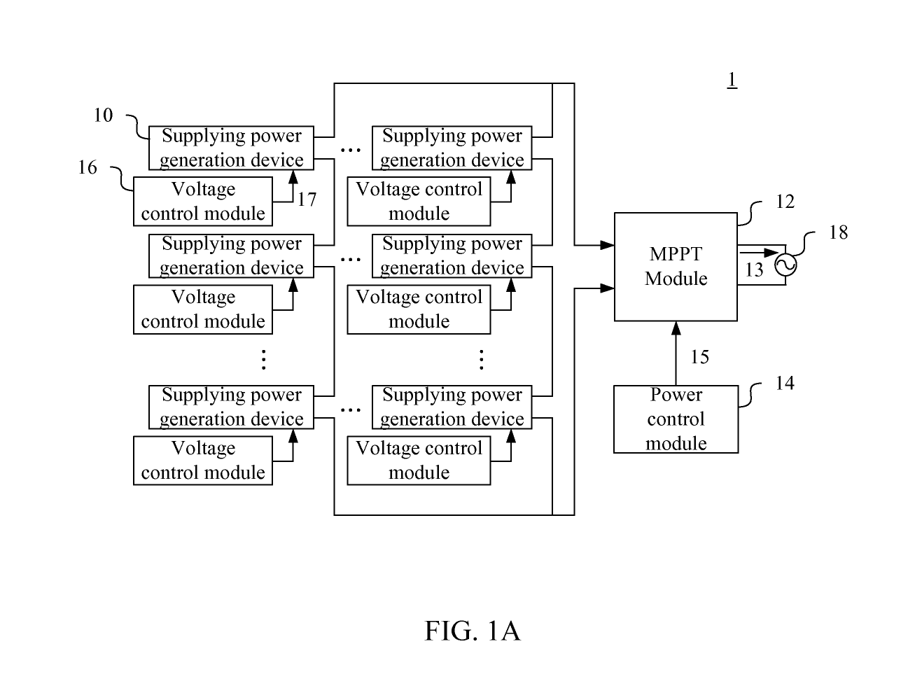

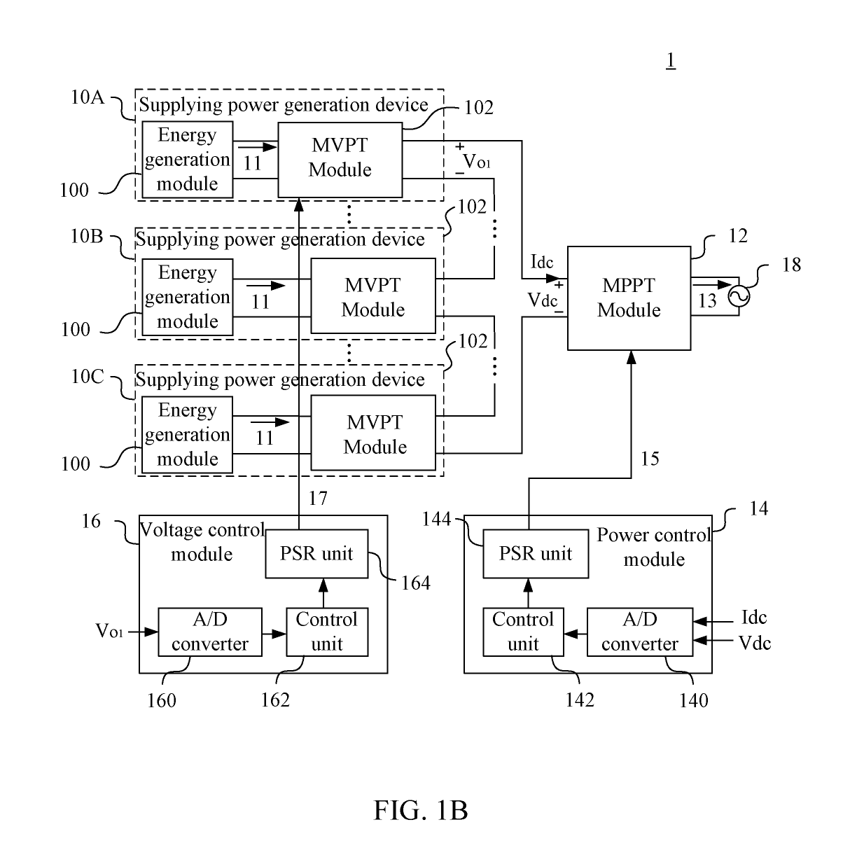

FIG. 1A is a block diagram of a power generation control system 1 in an embodiment of the present invention. FIG. 1B is a detail block diagram of the power generation control system 1 illustrated in FIG. 1A in an embodiment of the present invention. The power generation control system 1 includes a plurality of supplying power generation devices 10, a maximum power point tracking (MPPT) module 12, a power control module 14 and a plurality of voltage control modules 16. In FIG. 1B, only a column of the supplying power generation devices 10 in FIG. 1A are depicted, in which the supplying power generation devices in FIG. 1B are labeled as 10A, 10B and 10C respectively.

As illustrated in FIG. 1A, the supplying power generation devices 10 are electrically connected in series and/or in parallel to form an array. In the present embodiment, the power generation control system 1 includes a plurality of columns of the supplying power generation devices 10 that are connected in parallel, in which the supplying power generation devices 10 in each of the columns are connected in series. It is noted that the array illustrated in FIG. 1A is merely an example. In other embodiments, other forms of array can be used depending on practical needs.

A column of three supplying power generation devices 10A, 10B and 10C are exemplary illustrated in FIG. 1B. However, in other embodiments, the number of the supplying power generation devices is not limited by the number illustrated in FIG. 1B and can be adjusted depending on practical needs. In an embodiment, the configurations of the supplying power generation devices 10A, 10B and 10C are the same, in which the supplying power generation device 10A is used as the example in the following description. The supplying power generation device 10A includes an energy generation module 100 and a maximum voltage point tracking (MVPT) module 102.

The energy generation module 100 can be such as, but not limited to a solar cell module or other types of renewable energy generation module. The energy generation module 100 generates an input supplying power 11. The MVPT module 102 is electrically connected to the energy generation module 100 for performing a MVPT process on the input supplying power 11 to generate an output supplying power having an output voltage Vₒ₁.

The MPPT module 12 is electrically connected to the two ends of the supplying power generation devices 10A, 10B and 10C for receiving a total output supplying power from the supplying power generation devices 10A, 10B and 10C. The total output supplying power has a total output voltage Vdc and a total output current Idc. The MPPT module 12 performs a MPPT process on the total output supplying power generated from the supplying power generation devices 10A, 10B and 10C to generate a maximum supplying power 13 having a maximum power. In an embodiment, the maximum supplying power 13 is further transmitted to a power grid 18. In an embodiment, the MPPT module 12 is integrated in a DC to AC (direct current to alternating current) converter (not illustrated) to perform the MPPT process when the DC-AC converter converts the total output supplying power in a DC form to an AC form.

The power control module 14 is electrically connected to the MPPT module 12 for generating a first duty cycle control signal 15 according to the total output voltage Vdc and the total output current Idc of the total output supplying power. The first duty cycle control signal 15 adjusts the duty cycle of the MPPT module 12 to perform the MPPT process.

In an embodiment, the power control module 14 further includes an analog to digital converter 140, a control unit 142 and a power stage regulator (PSR) unit 144. The analog to digital (A/D) converter 140 converts the total output voltage Vdc and the total output current Idc from the analog form to the digital form. The control unit 142 controls the power stage regulator unit 144 to generate the first duty cycle control signal 15 according to the total output voltage Vdc and the total output current Idc. In an embodiment, the control unit 142 determines a slope of a rate of power change of a total output power according to the total output voltage Vdc, the total output current Idc and an algorithm stored therein. The control unit 142 further determines that the total output supplying power reaches the maximum output power when an absolute value of the slope is smaller than a predetermined threshold value of the rate of power change.

It is noted that the configuration of the power control module 14 illustrated in FIG. 1B is merely an example. In other embodiments, other forms of the configuration of hardware in the power control module 14 can be used.

The voltage control module 16 is electrically connected to the MVPT module 102 of the supplying power generation device 10A for generating a second duty cycle control signal 17 according to the output voltage Vₒ₁ of the output supplying power. The second duty cycle control signal 17 adjusts the duty cycle of the MVPT module 102 to perform the MVPT process.

In an embodiment, similar to the power control module 14, the voltage control module 16 further includes an analog to digital converter 160, a control unit 162 and a power stage regulator unit 164. The analog to digital converter 160 converts the output voltage Vₒ₁ from the analog form to the digital form. The control unit 162 controls the power stage regulator unit 164 to generate the second duty cycle control signal 17 according to the output voltage Vₒ₁. In an embodiment, the control unit 162 determines a slope of a rate of voltage change of the output voltage Vₒ₁ according an algorithm stored therein. The control unit 162 further determines that the output voltage Vₒ₁ reaches the maximum output voltage when an absolute value of the slope is smaller than a predetermined threshold value of the rate of voltage change.

It is noted that the configuration of the voltage control module 16 illustrated in FIG. 1B is merely an example. In other embodiments, the configuration of hardware in other forms can be used. Moreover, in FIG. 1B, only the voltage control module 16 corresponding to the supplying power generation device 10A is illustrated. Actually, the power generation control system 1 further includes other voltage control modules (not illustrated) corresponding to the supplying power generation device 10B and 10C respectively to perform the operations described above.

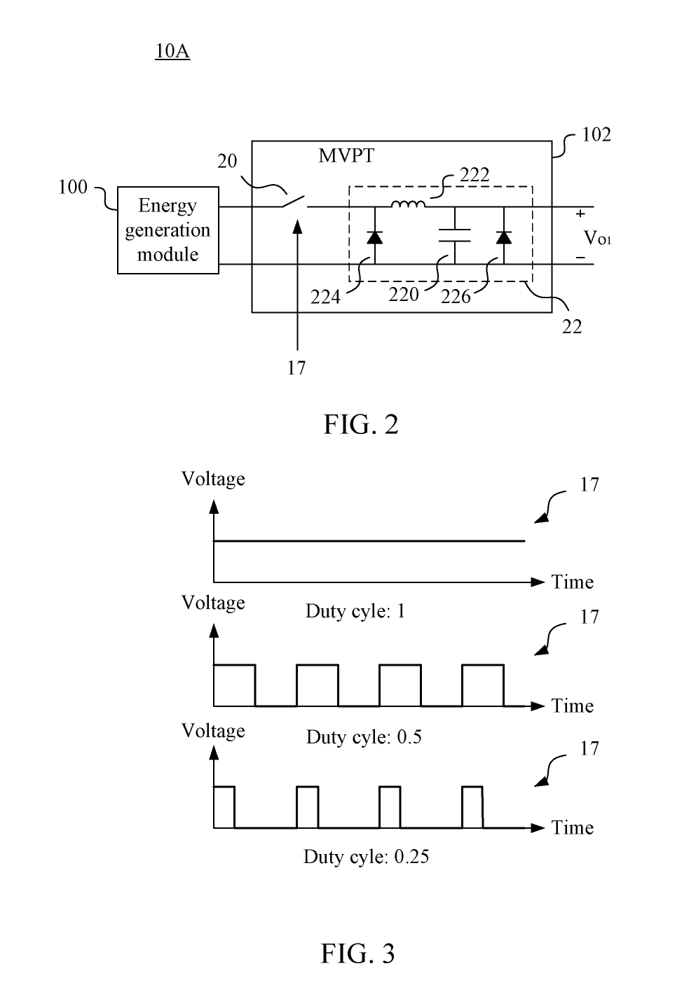

FIG. 2 is a detail circuit diagram of the supplying power generation device 10A in an embodiment of the present invention. FIG. 3 is a waveform diagram of a plurality of examples of the second duty cycle control signal 17 having different duty cycles in an embodiment of the present invention. As illustrated in FIG. 2, the MVPT module 102 electrically connected to the energy generation module 100 further includes a current switch 20 and a LC circuit 22.

The current switch 20 is operated to be electrically conducted or electrically unconducted according to the second duty cycle control signal 17. In an embodiment, the second duty cycle control signal 17 operates the current switch 20 to be electrically conducted during the high level and operates the current switch to be electrically unconducted during the low level, as illustrated in FIG. 3. However, the high level and the low level can be adjusted according to practical conditions and are not limited by the levels illustrated in FIG. 3.

The LC circuit 22 is electrically connected to the energy generation module 100 through the current switch 20. The LC circuit 22 in different supplying power generation devices 10A, 10B or 10C is either electrically connected to two of the neighboring supplying power generation devices (e.g. the LC circuit 22 in the supplying power generation devices 10B) or is either electrically connected to one of the neighboring supplying power generation devices and the MPPT module 12 (e.g. the LC circuits 22 in the supplying power generation devices 10A and 10C).

In an embodiment, the LC circuit 22 includes at least a capacitor 220 and an inductor 222 and selectively includes diodes 224 and 226 that provide a voltage-stabilizing mechanism. It is noted that the LC circuit 22 illustrated in FIG. 2 is merely an example. In other embodiments, other circuits can be used to implement the LC circuit 22. The LC circuit 22 generates the output supplying power Vₒ₁ according to the current switch 20 that is operated to be electrically conducted or electrically unconducted.

For example, when the duty cycle of the second duty cycle control signal 17 is 1, the second duty cycle control signal 17 is in the high state to keep operating the current switch 20 to be electrically conducted. When the duty cycle of the second duty cycle control signal 17 is 0.5, the second duty cycle control signal 17 is in the high state in half of a time period. The current switch 20 is operated to be electrically conducted in half of the time period accordingly. When the duty cycle of the second duty cycle control signal 17 is 0.25, the second duty cycle control signal 17 is in the high state in ¼ part of a time period. The current switch 20 is operated to be electrically conducted in ¼ part of the time period accordingly.

Therefore, by adjusting the durations of the electrically conducted state and the electrically unconducted state of the current switch 20 according to the second duty cycle control signal 17, the output current and the output voltage of the output supplying power are adjusted correspondingly. As described above, since the second duty cycle control signal 17 is generated according to the output voltage Vₒ₁ of the output supplying power, the output voltage Vₒ₁ is adjusted by the feedback mechanism and is adjusted to reach the maximum output voltage gradually. The MVPT process is therefore accomplished.

In an embodiment, the MPPT module 12 is implemented in a similar configuration as that of the MVPT module 102. The first duty cycle control signal 15 is gradually adjusted according to the feedback of the total output voltage Vdc and the total output current Idc such that the maximum output power is reached. The MPPT process is therefore accomplished.

In an embodiment, the MPPT process is performed first by the MPPT module 12 such that the total output supplying power having the maximum power is generated steadily by fixing the first duty cycle control signal 15 in the power generation control system 1. Subsequently, the MVPT process is performed by the MVPT module 102 to generate the output power having the maximum output voltage.

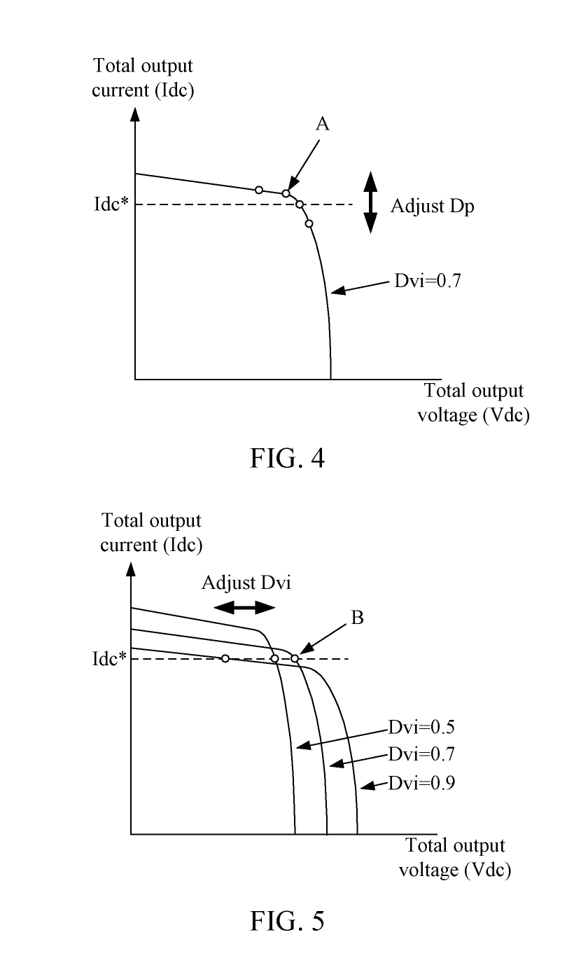

FIG. 4 and FIG. 5 are diagrams of the curves of the total output voltage Vdc and the total output current Idc of the total output supplying power in an embodiment of the present invention. The curve in FIG. 4 illustrates the condition of adjusting the duty cycle Dp of the first duty cycle control signal 15 when the duty cycle Dvi of the second duty cycle control signal 17 is fixed at 0.7. The curves in FIG. 5 illustrate the conditions of fixing the duty cycle Dp of the first duty cycle control signal 15 at the point A corresponding to the maximum power when the duty cycle Dvi of the second duty cycle control signal 17 is at 0.5, 0.7 and 0.9 respectively.

As illustrated in FIG. 4, when the duty cycle Dp is adjusted, the point of the total output power moves along the curve related to the total output voltage Vdc and the total output current Idc. By applying an appropriate algorithm, the point A having the maximum power can be tracked. When the point A is tracked, the duty cycle Dp of the first duty cycle control signal 15 is fixed. Moreover, the duty cycle Dvi corresponding to each of the MVPT module 102 is adjusted to track the maximum voltage of each of the output supplying powers. Hence, the total output supplying power reaches the maximum output voltage at the point B.

As a result, the power generation control system 1 only tracks the maximum power of the total output supplying power and the maximum voltage of the output supplying power of each of the supplying power generation devices 10A, 10B and 10C. The monitoring of the voltages and currents of all the supplying power generation devices 10A, 10B and 10C is not necessary. Moreover, the complex design of the circuits to perform the tracking of the maximum power of all the supplying power generation devices 10A, 10B and 10C is not necessary. The power generation control system 1 maintains a steady output supplying power even if part of the supplying power generation devices 10A, 10B and 10C do not function normally.

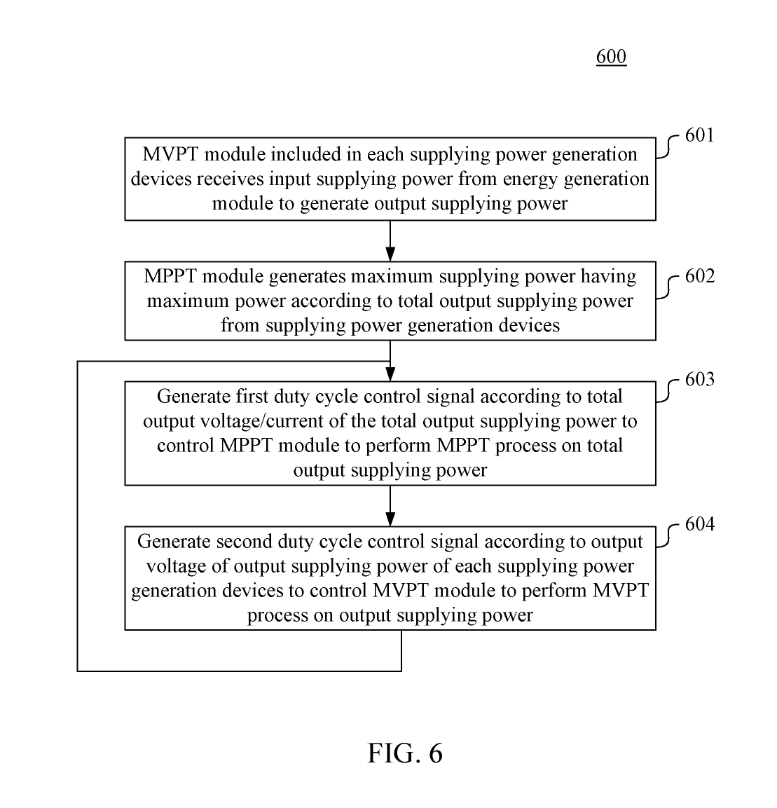

FIG. 6 is a flow chart of a power generation control method 600 in an embodiment of the present invention. The power generation control method 600 can be used in the power generation control system 1 illustrated in FIG. 1A and FIG. 1B. More specifically, the power generation control method 600 is implemented by using a computer program to control the modules in the power generation control system 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The power generation control method 600 includes the steps outlined below. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 601, the MVPT module 102 in each of the supplying power generation devices 10A, 10B and 10C is controlled to receive an input power 11 generated from the energy generation module 100 to generate an output supplying power.

In step 602, the MPPT module 12 is controlled to generate the maximum supplying power 13 having a maximum power according to the total output supplying power generated from the supplying power generation devices 10A, 10B and 10C.

In step 603, the first duty cycle control signal 15 is generated according to the total output voltage Vdc and the total output current Idc of the total output supplying power to control the MPPT module 12 to perform a MPPT process on the total output supplying power.

In step 604, the second duty cycle control signal 17 is generated according to the output voltage Vₒ₁ of the output supplying power of each of the supplying power generation devices 10A, 10B and 10C to control the MVPT module 102 to perform the MVPT process on the output supplying power.

When both of the MPPT process and the MVPT process are finished, the flow goes back to step 603 to perform the next tracking procedure. The maximum supplying power 13 generated by the power generation control system 1 is thus maintained at the maximum output power.

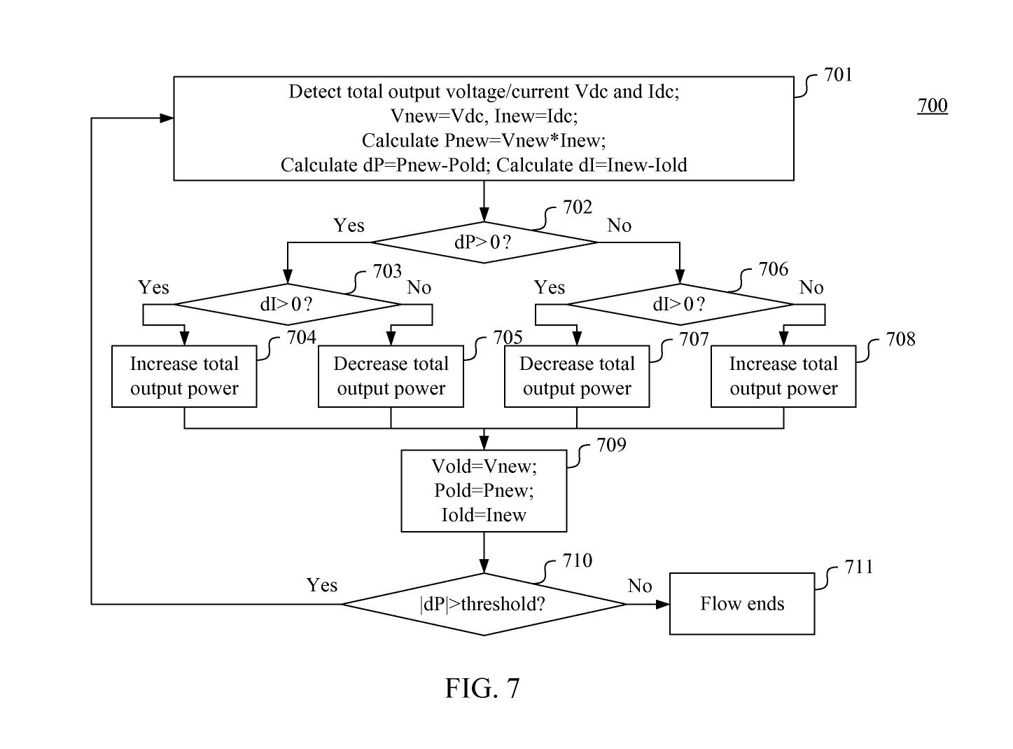

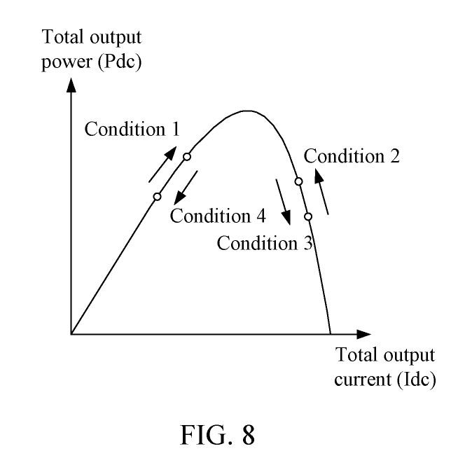

FIG. 7 is a flow chart of the MPPT process 700 in an embodiment of the present invention. FIG. 8 is a diagram illustrating a curve of the total output power Pdc and the total output current Idc of the total output supplying power in an embodiment of the present invention.

The MPPT process 700 can be used in the power control module 14 of the power generation control system 1 illustrated in FIG. 1A and FIG. 1B or in step 603 of FIG. 6. More specifically, the MPPT process 700 is implemented by using a computer program to control the modules in the power control module 14. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The MPPT process 700 includes the steps outlined below. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 701, the total output voltage Vdc and the total output current Idc of the total output supplying power are detected. The total output voltage Vdc is assigned to be a present output voltage Vnew and the total output current Idc is assigned to be a present output current Inew. Moreover, a present total output power Pnew is calculated.

The difference between the present total output power Pnew and a previous total output power Fold is calculated at the same time. The previous total output power Fold is calculated according to a previous total output voltage Vold and a previous total output current Iold. The calculated difference is served as the slope dP of the rate of power change of the total output power.

The difference between the present output current Inew and the previous total output current Iold is calculated at the same time. The calculated difference is served as the slope dI of the rate of current change of the total output current.

In step 702, whether the slope dP is larger than 0 is determined. When the slope dP is larger than 0, whether the slope dI is larger than 0 is determined in step 703.

When both of the slope dP and the slope dI are larger than 0, i.e. the condition 1 illustrated in FIG. 8, the total output current Idc is adjusted to be gradually increased. Moreover, the total output power Pdc is increased according to the adjustment of the total output current Idc. Under such a condition, the total output power is adjusted to be increased in step 704. The amount of the adjustment can be different depending on practical conditions and is not limited to a single value.

On the other hand, when the slope dP is determined to be smaller than 0 in step 702, whether the slope dI is larger than 9 is determined in step 706.

When the slope dP is smaller than 0 and the slope dI is larger than 0, i.e. the condition 3 illustrated in FIG. 8, the total output current Idc is adjusted to be gradually increased. However, the total output power Pdc is decreased according to the adjustment of the total output current Idc. Under such a condition, the total output power is adjusted to be decreased in step 707. The amount of the adjustment can be different depending on practical conditions and is not limited to a single value.

When both of the slope dP and the slope dI are smaller than 0, i.e. the condition 4 illustrated in FIG. 8, the total output current Idc is adjusted to be gradually decreased. Moreover, the total output power Pdc is decreased according to the adjustment of the total output current Idc. Under such a condition, the total output power is adjusted to be increased in step 708. The amount of the adjustment can be different depending on practical conditions and is not limited to a single value.

When the adjustment of the slope dP is finished in steps 704, 705, 707 and 708, the present total output voltage Vnew is assigned to be the previous total output voltage Vold in step 709. Further, the present total output current Inew is assigned to be the previous total output current Iold, and the present total output power Pnew is assigned to be the previous total output power Pold.

Whether the slope dP is larger than a threshold value of the rate of power change is determined in step 710. When the slope dP is larger than the threshold value, the flow goes back to step 701 to detect the total output voltage Vdc and the total output current Idc to perform the adjustment since the maximum of the total output power is not tracked yet. When the slope dP is smaller than the threshold value, the total output power is close to the maximum before the adjustment. Therefore, the maximum of the total output power is substantially reached after the adjustment. The flow ends in step 711.

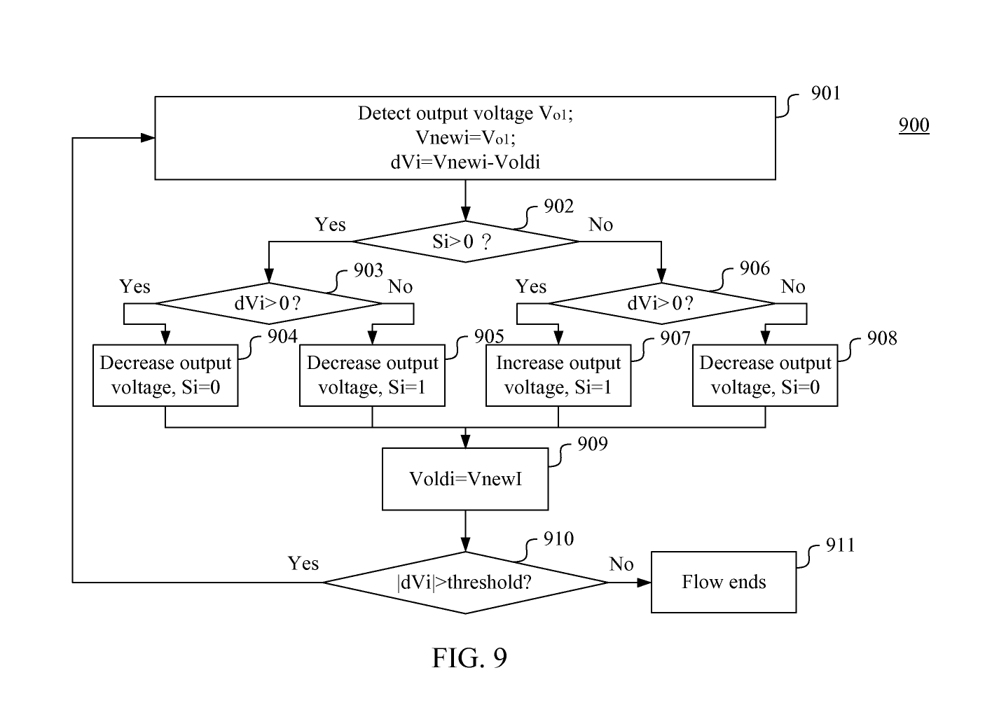

FIG. 9 is a flow chart of the MVPT process 900 in an embodiment of the present invention.

The MVPT process 900 can be used in the voltage control module 16 of the power generation control system 1 illustrated in FIG. 1A and FIG. 1B or in step 605 of FIG. 6. More specifically, the MVPT process 900 is implemented by using a computer program to control the modules in the voltage control module 16. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The MVPT process 900 includes the steps outlined below. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 901, the output voltage Vₒ₁ of the output power is detected. The output voltage Vₒ₁ is assigned to a present output voltage Vnewi. Further, a difference between the present output voltage Vnewi and a previous output voltage Voldi is calculated. The difference is served as a slope dVi of a rate of voltage change of the output voltage.

In step 902, whether a tendency of adjustment Si of the voltage is to decrease the voltage (Si=0) is determined. When the tendency of the adjustment Si is to decrease the voltage, whether the slope dVi is larger than 0 is determined in step 903.

When the tendency of the adjustment Si is to decrease the voltage and the slope dVi is larger than 0, the output voltage is decreased in step 904 and the tendency of the adjustment Si is kept to decrease the voltage.

When the tendency of the adjustment Si is to decrease the voltage and the slope dVi is smaller than 0, the output voltage is decreased in step 905 and the tendency of the adjustment Si is changed to increase the voltage (Si=1).

When the tendency of the adjustment Si is determined to increase the voltage in step 902, whether the slope dVi is larger than 0 is determined in step 906.

When the tendency of the adjustment Si is to increase the voltage and the slope dVi is larger than 0, the output voltage is increased in step 907 and the tendency of the adjustment Si is kept to increase the voltage.

When the tendency of the adjustment Si is to increase the voltage and the slope dVi is smaller than 0, the output voltage is decreased in step 908 and the tendency of the adjustment Si is changed to decrease the voltage.

When the adjustment of the slope dVi is finished in steps 904, 905, 907 and 908, the present output voltage Vnewi is assigned to be the previous output voltage Voldi in step 909.

Whether the slope dVi is larger than a threshold value of the rate of voltage change is determined in step 910. When the slope dVi is larger than the threshold value, the flow goes back to step 901 to detect the output voltage Vₒ₁ to perform the adjustment since the maximum of the output voltage is not tracked yet. When the slope dVi is smaller than the threshold value, the output voltage is close to the maximum before the adjustment. Therefore, the maximum of the output voltage is substantially reached after the adjustment. The flow ends in step 911.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A power generation control system comprising:
a plurality of supplying power generation devices electrically connected to form an array, each comprising:
an energy generation module for generating an input supplying power; and
a maximum voltage point tracking (MVPT) module electrically connected to the energy generation module for performing a MVPT process on the input supplying power to generate an output supplying power;
a maximum power point tracking (MPPT) module electrically connected to the supplying power generation devices for performing a MPPT process on a total output supplying power generated from the supplying power generation devices to generate a maximum supplying power having a maximum power;
a power control module electrically connected to the MPPT module for generating a first duty cycle control signal according to a total output voltage and a total output current of the total output supplying power to control the MPPT module to perform the MPPT process; and
a plurality of voltage control modules each electrically connected to the MVPT module of one of the supplying power generation devices for generating a second duty cycle control signal according to an output voltage of the output supplying power to control the MVPT module to perform the MVPT process.

2. The power generation control system of claim 1, wherein the MVPT module further comprises:
a current switch operated to be electrically conducted or electrically unconducted according to the second duty cycle control signal;
a LC circuit electrically connected to the energy generation module through the current switch for generating the output supplying power according to the current switch that is operated to be electrically conducted or electrically unconducted.

3. The power generation control system of claim 2, wherein the LC circuit is either electrically connected to two of the neighboring supplying power generation devices or electrically connected to one of the neighboring supplying power generation devices and the MPPT module.

4. The power generation control system of claim 1, wherein the power control module adjusts the first duty cycle control signal to subsequently determine a slope of a rate of power change of a total output power according to the total output voltage and the total output current, and determines that the total output supplying power reaches a maximum output power when an absolute value of the slope is smaller than a threshold value of the rate of power change.

5. The power generation control system of claim 1, wherein each of the voltage control modules adjusts the second duty cycle control signal to subsequently determine a slope of a rate of voltage change of the output voltage, and determines that the output supplying power reaches a maximum output voltage when an absolute value of the slope is smaller than a threshold value of the rate of voltage change.

6. The power generation control system of claim 1, wherein each of the voltage control modules controls the MVPT module in each of the supplying power generation devices to perform the MVPT process after the power control module controls the MPPT module to perform the MPPT process.

7. The power generation control system of claim 1, wherein the energy generation module is a solar cell module.

8. The power generation control system of claim 1, wherein the MPPT module transmits the maximum supplying power to a power grid.

9. A power generation control method used in a power generation control system, wherein the power generation control method comprises:
controlling a MVPT module in each of a plurality of supplying power generation devices connected in series to receive an input power generated from an energy generation module to generate an output supplying power;
controlling a MPPT module to generate a maximum supplying power having a maximum power according to a total output supplying power generated from the supplying power generation devices;
generating a first duty cycle control signal according to a total output voltage and a total output current of the total output supplying power to control the MPPT module to perform a MPPT process on the total output supplying power; and
generating a second duty cycle control signal according to an output voltage of the output supplying power of each of the supplying power generation devices to control the MVPT module to perform the MVPT process on the output supplying power.

10. The power generation control method of claim 9, further comprising:
operating a current switch comprised in the MVPT module to be electrically conducted or electrically unconducted according to the second duty cycle control signal; and
controlling a LC circuit electrically connected to the energy generation module through the current switch to generate the output supplying power according to the current switch that is operated to be electrically conducted or electrically unconducted.

11. The power generation control method of claim 10, wherein the LC circuit is either electrically connected to two of the neighboring supplying power generation devices or is either electrically connected to one of the neighboring supplying power generation devices and the MPPT module.

12. The power generation control method of claim 9, wherein the MPPT process further comprises:
adjusting the first duty cycle control signal;
determining a slope of a rate of power change of a total output power according to the total output voltage and the total output current; and
determining that the total output supplying power reaches a maximum output power when an absolute value of the slope is smaller than a threshold value of the rate of power change.

13. The power generation control method of claim 9, wherein the MVPT process further comprises:
adjusting the second duty cycle control signal;
determining a slope of a rate of voltage change of the output voltage; and
determining that the output supplying power reaches a maximum output voltage when an absolute value of the slope is smaller than a threshold value of the rate of voltage change.

14. The power generation control method of claim 9, wherein the MVPT process is performed after the MPPT process is performed.

15. The power generation control method of claim 9, further comprising:
transmitting the maximum supplying power to a power grid.

16. A non-transitory computer readable storage medium to store a computer program to execute a power generation control method used in a power generation control system, wherein the power generation control method comprises:
controlling a MVPT module in each of a plurality of supplying power generation devices connected in series to receive an input power generated from an energy generation module to generate an output supplying power;
controlling a MPPT module to generate a maximum supplying power having a maximum power according to a total output supplying power generated from the supplying power generation devices;
generating a first duty cycle control signal according to a total output voltage and a total output current of the total output supplying power to control the MPPT module to perform a MPPT process on the total output supplying power; and
generating a second duty cycle control signal according to an output voltage of the output supplying power of each of the supplying power generation devices to control the MVPT module to perform the MVPT process on the output supplying power.

17. The non-transitory computer readable storage medium of claim 16, wherein the power generation control method further comprises:
operating a current switch comprised in the MVPT module to be electrically conducted or electrically unconducted according to the second duty cycle control signal; and
controlling a LC circuit electrically connected to the energy generation module through the current switch to generate the output supplying power according to the current switch that is operated to be electrically conducted or electrically unconducted.

18. The non-transitory computer readable storage medium of claim 17, wherein the LC circuit is either electrically connected to two of the neighboring supplying power generation devices or is either electrically connected to one of the neighboring supplying power generation devices and the MPPT module.

19. The non-transitory computer readable storage medium of claim 16, wherein the MPPT process further comprises:
adjusting the first duty cycle control signal;
determining a slope of a rate of power change of a total output power according to the total output voltage and the total output current; and
determining that the total output supplying power reaches a maximum output power when an absolute value of the slope is smaller than a threshold value of the rate of power change.

20. The non-transitory computer readable storage medium of claim 16, wherein the MVPT process further comprises:
adjusting the second duty cycle control signal;
determining a slope of a rate of voltage change of the output voltage; and
determining that the output supplying power reaches a maximum output voltage when an absolute value of the slope is smaller than a threshold value of the rate of voltage change.

21. The non-transitory computer readable storage medium of claim 16, wherein the MVPT process is performed after the MPPT process is performed.

22. The non-transitory computer readable storage medium of claim 16, further comprising:
transmitting the maximum supplying power to a power grid.
